(19) United States
(12) Patent Application Publication
(10) Pub. No.: US 2014/0006321 A1
(43) Pub. Date: Jan. 2, 2014

(54) METHOD FOR IMPROVING AN AUTOCORRECTOR USING AUTO-DIFFERENTIATION

(71) Applicant: Georges Harik, Palo Alto, CA (US)

(72) Inventor: Georges Harik, Palo Alto, CA (US)

(21) Appl. No.: 13/931,440

(22) Filed: Jun. 28, 2013

Related U.S. Application Data
(60) Provisional application No. 61/666,508, filed on Jun. 29, 2012.

(51) Int. Cl. G06N 99/00

(52) U.S. Cl. CPC G06N 99/005
USPC 706/12

(57) ABSTRACT

A method and an apparatus allow learning a program that is characterized by a set of parameters. In addition to carrying out operations of the program based on an input vector and the values of the parameters, the method also carries out automatic differentiation steps over the operations of the program to compute derivatives of the output vector with respect to the parameters to any desired order. Based on the computed derivatives, the values of the parameters of the program are updated.

### CROSS REFERENCE TO RELATED PATENT APPLICATIONS

The present invention is related to and claims priority of U.S. provisional patent application (“Copending Provisional Application”), Ser. No. 61/666,508, entitled “Method for Improving an AutoCorrector,” filed on Jun. 29, 2012. The disclosure of the Provisional Application is hereby incorporated by reference in its entirety.

### BACKGROUND OF THE INVENTION

1. Field of the Invention

The present invention relates to improving performance in programs that learn (e.g., an autocorrector) in any computational environment. In particular, the present invention relates to introducing an automatic differentiator into a computational model to improve performance in data prediction or optimization in any computational environment.

2. Discussion of the Related Art

Many complex problems are solved using programs that are adapted and improved (“learned” or “trained”) using known training data. For example, one class of such programs is known as “autocorrectors.” In this regard, an autocorrector is a program that, given incomplete, inconsistent or erroneous data, returns corrected data, based on learning and the computational model implemented. For example, an autocorrector trained on newspaper articles of the last century, given the words “Grovar Bush, President of” as input, may be expected to return corrected and completed statements, such as “George W. Bush, President of the United States,” “George H. W. Bush, President of the United States,” or “Vannevar Bush, President of MIT.”

Neural network techniques have been applied to building autocorrectors, as neural network techniques have been successfully used to exploit hidden information inherent in data. A neural network model is usually based on a graph consisting of (a) nodes that are referred to as “neurons” and (b) directed, weighted edges connecting the neurons. When implemented in a computational environment, the directed graph of the neural network model typically represents a function that is computed in the computational environment. In a typical implementation, each neuron is assigned a simple computational task (e.g., a linear transformation followed by a squashing function, such as a logistic function) and a loss function is computed over the entire neural network model. The parameters of the neural network model are typically determined or learned using a method that involves minimizing or optimizing the loss function. A large number of techniques have been developed to minimize the loss function. One such method is “gradient descent,” which is computed by finding analytical gradients for the loss functions and perturbing or moving the test values according to the direction of the gradient.

One specialized neural network model, called an autoencoder, has been gaining adherents recently. In the autoencoder, the function that is to be learned is the identity function, and the loss function is a reconstruction error computation on the input values themselves. One technique achieves effective learning of a hidden structure in the data by requiring the function to be learned with fewer intermediate neurons than the values in the input vector itself The resulting neural network model may then be used in further data analysis. As an example, consider the data of a 100×100 pixel black-and-white image, which may be represented by 10000 input neurons. If the intermediate layer of the computation in a 3-layer network is constrained to having only 1000 neurons, the identity function is not trivially learnable. However, the resulting connections between the 10000 input neurons and the 1000 neurons in the hidden layer of the neural network model would represent to some extent the interesting structure in the data. Once the number of neurons in such an intermediate layer begins to approach 10000 then the trivial identity mapping becomes a more likely local optimum to be found by the training process. The trivial identity mapping, of course, would fail to discover any hidden structure of the data.

An interesting technique to allow a large number of intermediate neurons to be used is the “denoising autoencoder.” In a denoising autoencoder, the input values are distorted, but the network is still evaluated based on its ability to reconstruct the original data. Consequently, the identity function is not generally a good local optimum, and thereby allows a larger hidden layer (i.e., with more neurons) to be available to learn more relationships inherent in the data.

### SUMMARY

According to one embodiment of the present invention, a method and an apparatus are provided for learning a program that is characterized by a set of parameters. In addition to carrying out operations of the program based on the input vector and the values of the parameters, the method of the present invention also carries out automatic differentiation steps over the operations of the program to compute derivatives of the output vector with respect to some or all of the parameters to any desired order. Based on the computed derivatives, the values of the parameters of the program may be updated.

According to one embodiment of the present invention, for each operation of the program which transforms a set of input values and a set of parameter values to obtain a set of output values, a method stores the input values, intermediate values computed during the operation, the set of parameter values and the output values in a record of a predetermined data structure. The derivatives may then be readily computed in a “roll back” of the program execution, by applying the chain rule to data stored in the records of the predetermined data structure.

The values of the parameters may be updated based on evaluation of an optimization model (e.g., using a gradient descent technique) from the computed derivatives.

According to one embodiment of the present invention, the operations of the program may include dynamic program structures. The derivatives are computed based on the operations actually carried out in the dynamic program structures.

The present invention provides a method for creating autocorrectors that can be implemented in any arbitrary computational model. The autocorrectors of the present invention are therefore not constrained by the building blocks, for example, of a neural network model.

The present invention is better understood upon consideration of the detailed description below.

### BRIEF DESCRIPTION OF THE DRAWINGS

FIG. 1 is a block diagram of one implementation of program learning system 100, according to one embodiment of the present invention.

### DETAILED DESCRIPTION OF THE PREFERRED EMBODIMENTS

The present invention provides a method which is applicable to programs that are learned using a large number of parameters. One example of such programs is an autocorrector, such as any of those described, for example, in copending U.S. patent application (“Copending AutoCorrector Application”), Ser. No. 13/921,124, entitled “Method and Apparatus for Improving Resilience in Customized Program Learning Computational Environments,” filed on Jun. 18, 2013. The disclosure of the Copending AutoCorrector Application is hereby incorporated by reference in its entirety.

To facilitate program learning, the present invention uses a technique that is referred to as automatic differentiation. Automatic differentiation takes advantage of the fact that a computer program, no matter how complex, executes a sequence of arithmetic operations and elementary functions (e.g., sine, cosine, or logarithm). Using the chain rule, an automatic differentiator automatically computes the derivatives of some or all of the parameters of the program to any desired order. Discussion of automatic differentiators may be found for example, at http://en.wikipedia.org/wiki/Automatic_differentiation.

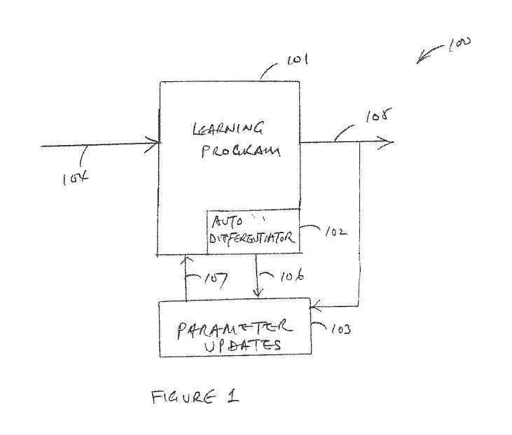

Although the present invention is described in this detailed description by way of an exemplary autocorrector, application of the present invention is not limited to autocorrector programs, but extends to most programs that are learned through an optimization of program parameters. FIG. 1 is a block diagram of one implementation of program learning system 100, according to one embodiment of the present invention. As shown in FIG. 1, program learning system 100 includes learning program 101, which receives input vector 104 and parameter values 107 to provide output vector 105. Learning program 101 may be, for example, an autocorrector. Integrated into learning program 101 is auto-differentiation module 102 which carries out automatic differentiation operations as the input vector is processed in learning program 101. Along with the output vector, the computed derivatives (derivative output data 106) are provided to parameter update module 103. Derivative output data 106 may be useful in updating program parameters under such optimization approaches as the gradient descent techniques. The updated parameters are fed back into configuring learning program 101. Techniques such as input and parameter distortion described in the Copending AutoCorrector Application may also be applied.

For any given set of data, the automatic differentiator examines the program and evaluates the derivatives of some or all functions or expressions that include variables of continuous values. In this regard, a floating point number in a program may be assumed to be the value of a continuous real variable. The automatic differentiator evaluates the derivatives at the values taken on by the variables at the time of evaluation. An automatic differentiator provides the surprising ability of easily measuring the gradient of a function in a program with respect to all other variables in the programs. For a loss function (e.g., those used in a neural network program model), the derivatives evaluated by the automatic differentiator are immediately available for optimization of program parameters. In an autoencoder-based autocorrector, for example, the loss function may measure the error between the predicted data and the input data.

Unlike prior art techniques which are constrained by the fixed computational units (e.g., linear transformations and squash functions in a neural network model), the method of the present invention uses an automatic differentiator which is practically completely general. This is accomplished by, for example, evaluating the derivatives using the dynamic values of the parameters simultaneously with execution of learning program 101. For example, the automatic differentiator of the present invention handles a learning program with conditional transfer of control. Consider the following program fragment involving parameter x of the program:

If x<1 then return x; else return x/2.0;

In the above program fragment, the automatically calculated derivative for parameter x is 1, when the value of parameter x is less than 1, but is ½ otherwise. However, which of the two branches is executed can only be determined dynamically, as the value of parameter x is known only at run time. Automatic differentiation allows the derivative to be computed based on the actual (i.e., dynamic) computations carried out, which cannot be done using a static approach. In addition, the automatic differentiation operations may be coupled to execution of elementary operators of the program model. For example, in the neural network program model, an automatic differentiator operation may be associated with each linear transformation (e.g., z=ax+by, where a and b are constants and x and y are parameter values). The chain rule allows the derivatives of an output with respect to input parameters to be computed as a product of the computed derivatives over a sequence of linear transformations, as the output value is developed from the input vector to output vector. One implementation stores in an appropriate data structure (e.g., a stack) a record of the intermediate values of the input data, the parameter values and the state variables involved in each operation associated with automatically computing the derivatives. The automatically computed derivatives are obtained at the end of program execution by a “roll back” through the accumulated records.

Efficient autocorrectors are applicable to problems such as prediction of future data of known systems, deducing missing data from databases, or answering questions posed to a general knowledge base. In the last example, a question can be posed as a set of data with a missing element. The question is answered when the autocorrector provides an output with the missing element filled in. In such an autocorrector, the general knowledge data base is incorporated into the computational structure of the autocorrector.

In one embodiment of the present invention, program learning system 100 may be implemented on a computational environment that includes a number of parallel processors. In one implementation, each processor may be a graphics processor, to take advantage of computational structures optimized for arithmetic typical in such processors. A host computer system using conventional programming techniques may configure program learning system 100 for each program to be learned. Learning program 101 may be organized, for example, as a neural network model. The program model implemented in learning program 101 may be variable, taking into account, for example, the structure and values of the input vector and the structure and values of the expected output data. Control flow in the program model may be constructed based on the input vector or intermediate values (“states values”) computed in the program model.

The present invention provides, for example, a method for creating autocorrectors that can be implemented in any arbitrary computational model. The autocorrectors of the present invention are therefore not constrained by the building blocks, for example, of a neural network model. Such autocorrectors, for example, may be implemented using any general programming language (e.g., Lisp or any of its variants). The methods provided in this detailed description may be implemented in a distributed computational environment in which one or more computing elements (e.g., neurons) are implemented by a physical computational resource (e.g., an arithmetic or logic unit). Implementing program learning system 100 in parallel graphics processors is one example of such an implementation. Alternatively, the methods may be implemented in a computational environment which represents each parameter in a customized data structure in memory, and a single processing unit processes program element in any suitable order. The methods of the present invention can also be implemented in a computational environment that is in between the previous two approaches.

The above detailed description is provided to illustrate the specific embodiments of the present invention and is not intended to be limiting. Various modification and variations within the scope of the present invention are possible. The present invention is set forth in the following claims.

1. A method for learning a program receiving an input vector and providing an output vector, the program being characterized by a set of parameters, comprising:
receiving the input vector into the learning program and the values of the parameters;
carrying out operations of the program;
carrying out automatic differentiation over the operations of the program to compute derivatives of the output vector with respect to the parameters to a desired order; and
based on the computed derivatives, updating the values of the parameters of the program.

2. The method of claim 1, wherein the method is repeated over all input vectors of an input set.

3. The method of claim 1, wherein, for each operation of the program, the operation transforming a set of input values and a set of parameter values to obtain a set of output values, carrying out automatic differentiation includes storing the input values, intermediate values computed during the operation, values of parameters involved in the operation and the output values in a record of a predetermined data structure.

4. The method of claim 3, wherein the derivatives are computed by applying the chain rule to data stored in the records of the predetermined data structure.

5. The method of claim 1, wherein the operations of the program include dynamic program structures, wherein the derivatives are computed based on the operations actually carried out in the dynamic program structures.

6. The method of claim 1, wherein the values of the parameters are updated based on evaluation of an optimization model using the computed derivatives.

7. The method of claim 6, wherein the optimization model uses a gradient descent technique.

8. An apparatus for learning a program that receives an input vector and provides an output vector, the program being characterized by a set of parameters, the apparatus comprising:
one or more execution units configured for carrying out:
operations of the program for computing the output vector, based on the input vector and the values of the a parameters;
automatic differentiation steps over the operations of the program to compute derivatives of the output vector with respect to the parameters to a desired order; and
parameter update steps, based on the computed derivatives, for updating the values of the parameters of the program.

9. The apparatus of claim 8, wherein the program is learned over all input vectors of an input set.

10. The apparatus of claim 8 wherein each operation of the program transforms a set of input values and a set of parameter values to obtain a set of output values, and wherein the automatic differentiation steps include storing the input values, intermediate values computed during the operation, the values of parameter involved in the operation and the output values in a record of a predetermined data structure.

11. The apparatus of claim 10, wherein the derivatives are computed by applying the chain rule to data stored in the records of the predetermined data structure.

12. The apparatus of claim 8, wherein the operations of the program include dynamic program structures, wherein the derivatives are computed based on the operations actually carried out in the dynamic program structures.

13. The apparatus of claim 8, wherein the values of the parameters are updated based on evaluation of an optimization model using the computed derivatives.

14. The apparatus of claim 13, wherein the optimization model uses a gradient descent technique.

15. The apparatus of claim 8, wherein the execution units comprise one or more graphics processors configured in a parallel fashion.
